(19) United States
(12) Patent Application Publication
(10) Pub. No.: US 2025/0315160 A1
(43) Pub. Date: Oct. 9, 2025

(54) DEVICE AND METHOD OF INPUTTING CHARACTERS

(71) Applicant: Bonggeun Kim, Seoul (KR)

(72) Inventor: Bonggeun Kim, Seoul (KR)

(21) Appl. No.: 18/639,961

(22) Filed: Apr. 19, 2024

(30) Foreign Application Priority Data
Apr. 4, 2024 (KR) 10-2024-0045623

(51) Int. Cl. G06F 3/04886; G06F 3/04842

(52) U.S. Cl. CPC G06F 3/04886; G06F 3/04842

(57) ABSTRACT

A method includes receiving an input of a first text line selection associated with a first text line if characters are positioned in a plurality of text lines including the first text line and a second text line in a text input area, receiving an input of a first character key associated with a first character among a plurality of keys, and providing the first character in the first text line associated with the first text line selection and a first blank character in each of the plurality of text lines except the first text line in the text input area.

### CROSS-REFERENCE TO RELATED APPLICATION

This application claims the benefit of and priority to Korean Patent Application No. 10-2024-0045623, filed on Apr. 4, 2024, which is incorporated herein by reference in its entirety.

### FIELD

The disclosure relates to technologies for inputting characters which allows a device to be used to facilitate inputting characters.

### BACKGROUND

With the widespread use of mobile devices such as smartphones and tablet computers, the volume of messages exchanged by users on social network services (SNS) has greatly increased. Recently, various user interface technologies have been developed for mobile device keyboards, such as changing a key arrangement of a keyboard or incorporating emojis into the key arrangement, to enhance the convenience of a user's message input. Furthermore, as the number of applications used on mobile devices increases, the types of SNS applications have become very diverse. In this regard, there is still a demand for technologies to make a text representation even more diverse.

### SUMMARY

In an aspect, a device and a method of inputting characters to facilitate inputting characters are disclosed.

A method of inputting characters according to an embodiment of the disclosure is a method that may be performed in a device having a text input area and a keyboard area. The keyboard area includes a plurality of keys. The method includes receiving, in the keyboard area, an input of a first text line selection associated with a first text line if characters are positioned in a plurality of text lines including the first text line and a second text line in the text input area, receiving an input of a first character key associated with a first character among the plurality of keys, and providing, in response to the input of the first character key, the first character in the first text line associated with the first text line selection and a first blank character in each of the plurality of text lines, except the first text line, including the second text line in the text input area.

In some embodiments, the plurality of keys may further include a text line selection key. The input of the first text line selection may include a key input on the text line selection key.

In some embodiments, the text line selection key may be configured for a text line associated with the text line selection key to be changed periodically among the plurality of text lines based on a count of key inputs on the text line selection key.

In some embodiments, the text line selection key may be configured to be associated with the first text line if the count of key inputs on the text line selection key is odd, and the text line selection key may be configured to be associated with the second text line if the count of key inputs on the text line selection key is even.

In some embodiments, the input of the first text line selection may include a gesture input on the keyboard area.

In some embodiments, the gesture input may include at least one of a drag gesture, a swipe gesture, a tap gesture, and a pinch gesture.

In some embodiments, the first character may be a Unicode character or an emoji character.

In some embodiments, the emoji character may be an emoji character that is configured to have an animation effect.

In some embodiments, the first text line may be above the second text line in the text input area.

In some embodiments, a transverse difference between end positions of last characters, in a writing direction in each text line, among the characters positioned in the plurality of text lines including the first text line and the second text line may be equal to or less than a width of a character among the characters positioned in the plurality of text lines.

In some embodiments, the providing the first character in the first text line and the first blank character in each of the plurality of text lines except the first text line may include providing the first character in the first text line and a plurality of blank characters in each of the plurality of text lines except the first text line.

In some embodiments, widths of the plurality of blank characters may be different from each other in the text input area.

In some embodiments, after the providing the first character in the first text line and the first blank character in each of the plurality of text lines except the first text line, the method may further include receiving, in the keyboard area, an input of a second text line selection associated with the second text line, receiving, after the receiving the input of the second text line selection, an input of a second character key associated with a second character among the plurality of keys, and providing, in response to the input of the second character key, the second character in the second text line associated with the second text line selection and a second blank character in each of the plurality of text lines, except the second text line, including the first text line in the text input area.

In some embodiments, the second character may be provided in a diagonal direction in the text input area with respect to the first character.

In some embodiments, at least one of the first character and the second character may be a Unicode character.

In some embodiments, a width of the first blank character may be different from a width of the second blank character in the text input area.

In some embodiments, after the providing the second character in the second text line and the second blank character in each of the plurality of text lines except the second text line, the method may further include receiving an input of blank width adjustment in the keyboard area. A transverse distance between the first character in the first text line and the second character in the second text line may be configured to be changed in the text input area in response to the input of blank width adjustment.

In some embodiments, the input of blank width adjustment may include at least one of a gesture input on the keyboard area and a key input on a key among the plurality of keys.

In some embodiments, after the providing the second character in the second text line and the second blank character in each of the plurality of text lines except the second text line, the method may further include receiving, in the keyboard area, an input of a third text line selection associated with the first text line, receiving, after the receiving the input of the third text line selection, an input of a third character key associated with a third character among the plurality of keys, and providing, in response to the input of the third character key, the third character in the first text line associated with the third text line selection and a third blank character in each of the plurality of text lines, except the first text line, including the second text line in the text input area.

In some embodiments, the first character, the second character and the third character may be arranged in a zigzag manner in a height direction in the text input area.

In an aspect, a text input device according to an embodiment of the disclosure includes a key input unit, a display unit, and a control unit. The control unit is configured to execute computer-readable instructions. The instructions, when executed by the control unit, are configured for the control unit to display a text input area and a keyboard area on the display unit. The keyboard area includes a plurality of keys.

The instructions, when executed by the control unit, are configured for the control unit to receive, in the keyboard area, an input of a first text line selection associated with a first text line if characters are positioned in a plurality of text lines including the first text line and a second text line in the text input area, to receive an input of a first character key associated with a first character among the plurality of keys, and to provide, in response to the input of the first character key, the first character in the first text line associated with the first text line selection and a first blank character in each of the plurality of text lines, except the first text line, including the second text line in the text input area.

According to devices and methods of inputting characters as described herein, a device may be used to facilitate inputting characters in various representation.

### BRIEF DESCRIPTION OF THE DRAWINGS

FIG. 1 and FIG. 2 are exemplary drawings respectively illustrating a device according to embodiments of the disclosure.

FIG. 3 and FIG. 4 are exemplary drawings respectively illustrating a text input area of a device according to embodiments of the disclosure.

FIG. 5 is a flow chart illustrating a method of inputting characters according to an embodiment of the disclosure.

FIG. 6 is an exemplary drawing illustrating an input of a text line selection that may be performed in step S11 in a method of inputting characters according to an embodiment of the disclosure.

FIG. 7 and FIG. 8 are exemplary drawings respectively illustrating a text input area before step S11 in a method of inputting characters according to embodiments of the disclosure.

FIG. 9 and FIG. 10 are exemplary drawings respectively illustrating a text input area after step S13 in a method of inputting characters according to embodiments of the disclosure.

FIG. 11 is a flow chart illustrating a method of inputting characters according to an embodiment of the disclosure.

FIG. 12 and FIG. 13 are exemplary drawings respectively illustrating a text input area after step S23 in a method of inputting characters according to embodiments of the disclosure.

FIG. 14 and FIG. 15 are exemplary drawings respectively illustrating a text input area after step S23 in a method of inputting characters according to embodiments of the disclosure.

FIG. 16 and FIG. 17 are exemplary drawings respectively illustrating a text input area after step S23 in a method of inputting characters according to embodiments of the disclosure.

FIG. 18 is a flow chart illustrating a method of inputting characters according to an embodiment of the disclosure.

FIG. 19 and FIG. 20 are exemplary drawings respectively illustrating a text input area after step S33 in a method of inputting characters according to embodiments of the disclosure.

FIG. 21 and FIG. 22 are exemplary drawings respectively illustrating a text input area after step S33 in a method of inputting characters according to embodiments of the disclosure.

FIG. 23 is an exemplary drawing illustrating a text input area after step S33 in a method of inputting characters according to an embodiment of the disclosure.

FIG. 24 and FIG. 25 are exemplary drawings respectively illustrating a text input area after step S33 in a method of inputting characters according to embodiments of the disclosure.

### DETAILED DESCRIPTION

Embodiments of the disclosure are described in detail below with reference to the accompanying drawings.

Terms used throughout the specification may have meanings in nuances suggested or implied in the context beyond explicitly stated meanings.

Terms such as “in an embodiment”, “in an exemplary embodiment”, “in some embodiments”, or the like used in the disclosure may not necessarily refer to the same embodiment, while terms such as “in another embodiment”, “in another exemplary embodiment”, “in other embodiments”, or the like may refer to a different embodiment or may not necessarily refer to a different embodiment.

Terms such as “and”, “or”, and “and/or” used in the disclosure may include various meanings which may at least partially depend on the context in which they are used.

Terms such as “first”, “second”, “third”, or the like used in the disclosure may refer to various elements regardless of their order and/or importance, and they do not limit those elements. For example, a first element and a second element may refer to different elements regardless of their order and/or importance. For example, without departing from the scope described in the disclosure, a first element may be renamed as a second element, and similarly, a second element may be renamed as a first element.

In addition, terms such as “at least one”, and “one or more” used in the disclosure may be used, at least in part, depending on the context, to describe any feature, structure or property having a single element, or to describe features, structures or combination thereof having a plurality of elements.

Furthermore, terms such as “based on”, “in response to” and “responsive to” are not intended to describe an exclusive set of elements, but they are intended to, at least partially, allow the existence of additional elements which are not explicitly described, depending on the context.

Unless stated otherwise, all the technical and scientific terms used in the specification have the same meanings as those generally understood by one skilled in the art.

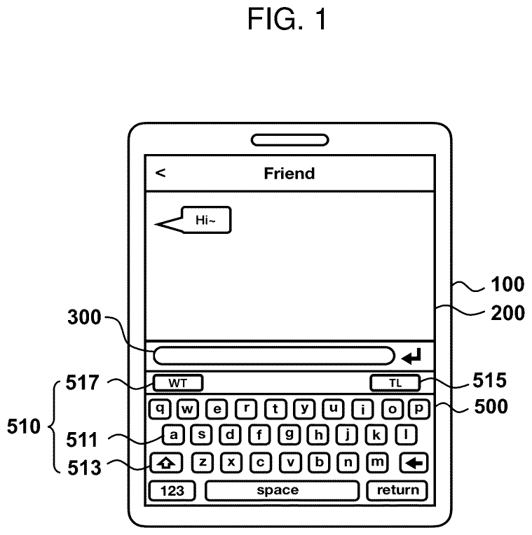

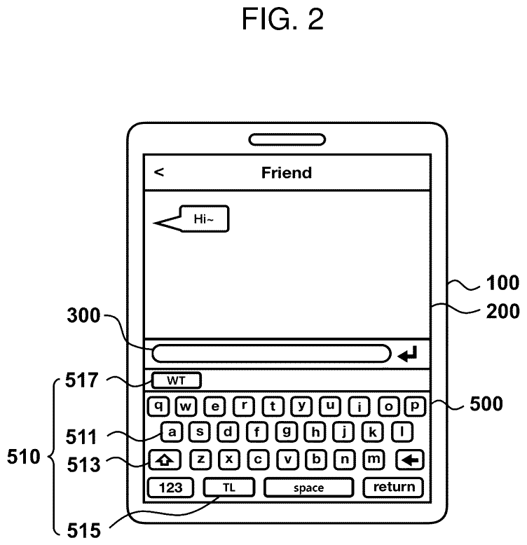

FIG. 1 and FIG. 2 are exemplary drawings respectively illustrating a device according to embodiments of the disclosure.

Referring to FIG. 1 and FIG. 2, a device 100 that a text input technology may be implemented according to embodiments of the disclosure may include a key input unit, a control unit (not shown), and a display unit 200. For example, if the device 100 includes a touchscreen, the key input unit may be implemented as a keyboard area 500 displayed on the display unit 200. For example, if the device 100 includes a virtual screen providing an augmented reality, a virtual reality, or the like, before an eye of a user, the key input unit may be implemented as a keyboard area displayed on the virtual screen.

The key input unit is a unit on which an input is provided from a user. The input from a user may include inputs by physical and direct contact(s) on the key input unit. Additionally, or alternatively, the input from a user may include indirect inputs by which the input is provided using separate intermediate devices/modules or wired and/or wireless connections including optical media, electrical media, electronic media, or a combination thereof, so that indirect inputs have substantially the same effect as physical inputs on the key input unit.

The control unit may be configured to provide a result (e.g., one or more Unicode characters, emoji characters, images, etc.) based on an input from a user (e.g., a key input, a gesture input, or the like), to an interface object in which the result is to be input (e.g., a text input area displayed on a screen as described below).

Although the device 100 is illustrated as a mobile device in FIG. 1 and FIG. 2, the device is not limited thereto. The device may be any electronic device configured to receive an input from a user (e.g., a key input, a gesture input, etc.), and to provide an interface object with a result of the input from the user (e.g., one or more Unicode characters, emoji characters, images, etc.).

For example, the device 100 may be a computing device that includes a processor (not shown), a memory (not shown) that computer-executable (and/or computer-readable) instructions are stored thereon, and a physical or virtual keyboard. The processor and the memory may be configured to operate as the control unit of the device 100. In some embodiments, the computing device may include, but not limited to, electronic devices such as personal computers, smartphones, tablet computers, or laptop computers. For example, the computing device may be an augmented reality device, a virtual reality device, etc. having a virtual screen.

The key input unit of the device 100 may be implemented including various types of optical elements, electrical elements, electronic elements, or combinations thereof. For example, if the device 100 includes a touchscreen as illustrated in FIG. 1 and FIG. 2, a part of the touchscreen may be configured to operate as the key input unit. For example, an input from a user may be received via keys 510 in a keyboard area 500 displayed on the touchscreen (including a virtual keyboard area). For example, an input from a user may be received via a gesture input on the keyboard area 500 displayed on the touchscreen.

The device 100 may be configured to display a text input area 300 and the keyboard area 500. The device 100 may be configured to provide, in the text input area 300, a result (e.g., one or more Unicode characters, emoji characters, images, etc.) based on an input from a user.

Referring to FIG. 1 and FIG. 2, the display unit 200 of the device 100 may be configured to display a screen (also referred to a “view”). A plurality of interface objects such as text, images, and graphical objects, etc. may be displayed on the screen. For example, in some embodiments, the interface objects may include a graphical user interface (GUI) object, a command line interface (CLI) object, and so on. The interface objects may include the text input area 300 in which text may be input.

For example, the text input area 300 may be a message input window in a message application. For example, the text input area 300 may be a message input window in an SNS application. However, the text input area 300 is not limited thereto. The text input area 300 may be any interface object that may allow a result of an input from a user via the key input unit of the device 100 to be displayed on the screen of the device 100 (including a virtual screen).

In the text input area 300, a plurality of characters (e.g., Unicode characters, emoji characters) may be provided. For example, alphabet, numbers, Hangul, Hiragana, Katakana, etc. may be provided in the text input area 300. However, characters that may be provided in the text input area 300 are not limited thereto. For example, emoji characters may be provided in the text input area 300. Emoji characters may include not only an emoji character belonging to the Unicode code system but also an emoji character not in the Unicode code system. For example, an emoji character may be an emoji character configured to have an animation effect. For example, an emoji character may be an emoji character including a graphics interchange format (GIF) image. In an embodiment, the text input area 300 of the device 100 may be configured to provide characters only in the Unicode code system. In an embodiment, the text input area 300 of the device 100 may be configured to provide a Unicode character and a non-Unicode emoji character.

Unicode is an industry standard code system introduced to consistently represent all the characters in the world. Unicode characters include a variety of non-letter characters such as numbers, phonetic symbols, symbols, and so on, as well as letters.

Generally, when a text processing is performed on a computing system, Unicode serves to provide a unique code point, i.e., a code value, for each character. In this case, Unicode determines as to which code point is to be represented as a character while a visual rendering (in certain sizes, fonts, styles, etc.) of the character may typically be determined by a text renderer, an operating system, and/or an application (a web browser, a document editing program, a text processing module, a messenger application, an SNS application, etc.).

For example, a Unicode character of code point U+0041 represents a Basic Latin alphabet capital letter ‘A’ (hereinafter, ‘U+’ followed by a number indicates a hexadecimal representation of code point in Unicode). In this case, it may be determined by an application (and/or an operating system, a module, etc.) that the Unicode character is text-processed (i.e., inputted, edited, etc.) in which size, in which font, and in what color the capital letter ‘A’ would be represented.

A Unicode character may have a unique code point ranging from U+0000 to U+10FFFF. A Unicode character may belong to a certain code block. For example, Unicode characters of code points in a range from U+25A0 to U+25FF may be characters belonging to the block of Geometric Shapes. In the disclosure, Unicode characters belonging to a plurality of code blocks may be provided in the text input area 300 in the device 100.

In some embodiments, an emoji character may be provided in the text input area 300 rather than a Unicode character. An emoji character may represent an image not associated with a Unicode code point. For example, an emoji character may represent a sequence of images having an animation effect. For example, an emoji character may represent an image having a graphics interchange format (GIF) format. For example, an emoji character may be a character that represents a various color effect such as red-green-blue (RGB) color, transparency, etc. when provided in the text input area 300.

In the text input area 300, a plurality of characters may be provided in two or more text lines. For example, if a new-line character (e.g., a text line delimiter such as a carriage return, a line feed, etc.) is provided in the text input area 300, text may be represented across different text lines. If text is provided across different text lines, a character before a new-line character may be represented in a different text line from a character after the new-line character. Additionally, or alternatively, text may be represented across different text lines if the total number of characters provided in the text input area 300 exceeds the number of characters which may be represented in a horizontal (or a transverse) length of a text line.

The keyboard area 500 may include a plurality of keys 510. The plurality of keys 510 may include, e.g., a character key 511, a special key 513, a text line selection key 515, a blank width adjustment key 517, and so on. The character key 511 may be a key associated with a Unicode character, an emoji character, and so on. The special key 513 may be a key associated a function, e.g., such as a change of uppercase/lowercase of character keys 511, a change of character keys 511 displayed in the keyboard area 500, an input of a new-line character (in case of a return key), a delete of a last character (in case of a delete key), and so on.

If characters are positioned in a plurality of text lines in the text input area 300, the text line selection key (TL) 515 may be a key associated with a selection of a text line in which a certain character is to be provided in the plurality of text lines.

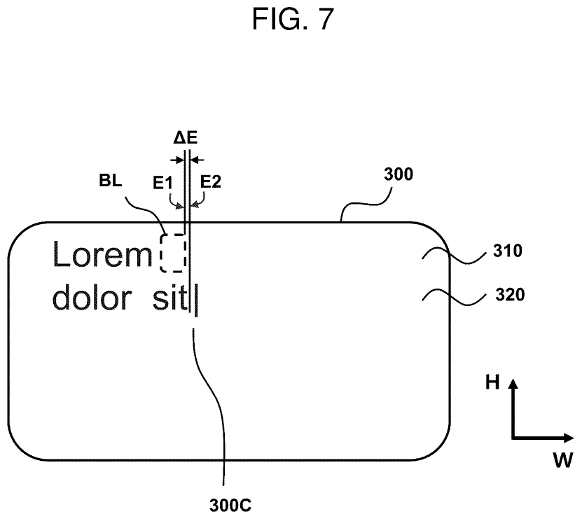

If characters are positioned in a plurality of text lines in the text input area 300, the blank width adjustment key (WT) 517 may be a key associated with a certain input and/or a certain modification in the plurality of text lines. The text line selection key (TL) 515 and the blank width adjustment key (WT) 517 are described in detail with reference to FIGS. 7 to 10, FIGS. 12 to 17, and FIGS. 19 to 25.

Although the blank width adjustment key (WT) 517 is positioned above a character key 511 and the text line selection key (TL) 515 is positioned above or below a character key 511 in FIG. 1 and FIG. 2, positions of the text line selection key (TL) 515 and the blank width adjustment key (WT) 511 in FIG. 1 and FIG. 2 are just examples, and they are not limited thereto. For example, like the text line selection key (TL) 515 in FIG. 2, the blank width adjustment key (WT) 517 may be positioned in substantially the same height position as a space key and a return key in the keyboard area 500. For example, the text line selection key (TL) 515 may be positioned in substantially the same height position as a shift key in the keyboard area 500.

Although a single text line selection key (TL) 515 is illustrated in FIG. 1 and FIG. 2, the number of text line selection keys (TL) 515 is not limited thereto. For example, if characters are positioned in a plurality of text lines in the text input area 300, a plurality of text line selection keys (TL) 515 equal to or less than the number of text lines in the plurality of text lines may be displayed in the keyboard area 500. For example, if characters are positioned in two text lines in the text input area 300, two text line selection keys (TL) 515 may be displayed in the keyboard area 500. In this case, one of the two text line selection keys (TL) 515 may be associated with a selection of one text line among the two text lines, and the other of the two text line selection keys (TL) 515 may be associated with a selection of the other text line among the two text lines. Hereinafter, for convenience of description, it is assumed that only one text line selection key (TL) 515 is displayed in the keyboard area 500.

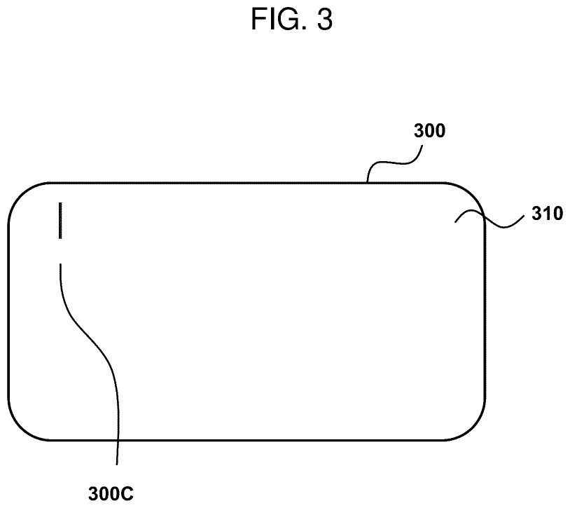

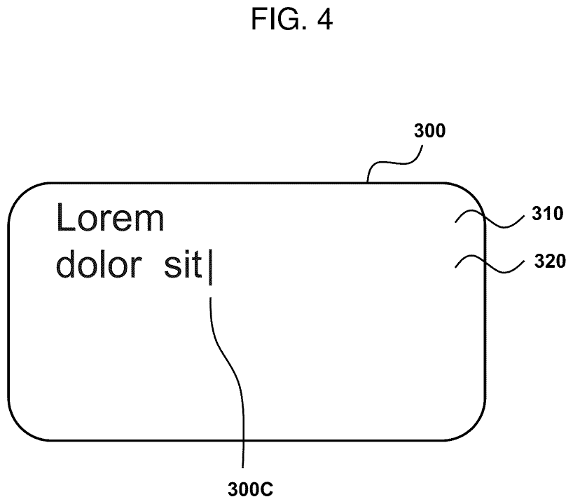

FIG. 3 and FIG. 4 are exemplary drawings respectively illustrating a text input area 300 of a device 100 according to embodiments of the disclosure. Referring to FIG. 3 and FIG. 4, a text input position 300C may be located in the text input area 300. For example, the text input position 300C may be indicated by, but not limited to, a bar flickering at a predetermined time interval.

The device 100 may be configured to provide characters at the text input position 300C in the text input area in response to an input from a user as described in detail below. Characters may be provided in a plurality of text lines such as a first text line 310, a second text line 320, etc. in the text input area 300. Characters may be provided at the text input position 300C in the text input area 300 in a writing direction of a certain language.

In the disclosure, the term “a writing direction of a language” refers to a direction that text is provided (e.g., input, printed, displayed, rendered, etc.) in the text input area 300. For example, in a left-to-right (LTR) direction that most languages such as English, Hangul, etc. are provided, text is provided from left to right in a width direction of the text input area 300. In an LTR direction, a new text line (and/or a new line) is provided below a previous text line.

Referring to FIG. 3 and FIG. 4, characters of “Lorem” are positioned in a first text line 310, and characters of “dolor sit” are positioned in a second text line 530 in an LTR direction in the text input area 300. Although it is not explicitly illustrated in FIG. 4, at least one blank character may be positioned after “Lorem” in the first text line 310 and/or after “dolor sit” in the second text line 320. Although it is not explicitly illustrated in FIG. 4, a new-line character may be positioned after a last character in the first text line 310.

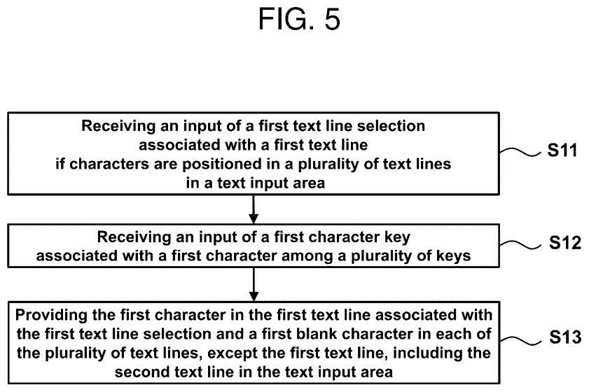

FIG. 5 is a flow chart illustrating a method of inputting characters according to an embodiment of the disclosure. Referring to FIG. 5, a method of inputting characters may include a step S11 of receiving an input of a first text line selection associated with a first text line if characters are positioned in a plurality of text lines in the text input area, a step S12 of receiving an input of a first character key associated with a first character among a plurality of keys, and a step S13 of providing the first character in the first text line associated with the first text line selection and a first blank character in each of the plurality of text lines, except the first text line, including the second text line in the text input area.

In step S11, the device 100 may be configured to receive an input of a first text line selection associated with a first text line if characters are positioned in a plurality of text lines in the text input area. The plurality of text lines may be two or more text lines. For example, the plurality of text lines may include the first text line 310, the second text line 320, etc. illustrated in FIG. 4.

The characters positioned in the plurality of text lines in the text input area may include a Unicode character, an emoji character, and so on. For example, characters of “Lorem” may be positioned in the first text line 310 in the text input area 300 as illustrated in FIG. 4. In some embodiments, at least one blank character may be further positioned after characters of “Lorem” in the first text line 310.

The first text line selection may include, e.g., a key input, a gesture input, etc. on the device 100 from a user. For example, if a text line selection key (TL) 515 is displayed in the keyboard area 500 of the device 100 as illustrated in FIG. 1 and FIG. 2, the first text line selection may include a key input on the text line selection key (TL) 515.

For example, referring to FIG. 4, if characters are positioned in a plurality of text lines 310 and 320 in the text input area 300, the text line selection key (TL) 515 may be associated with a selection of one text line (i.e., 310 or 320) among the plurality of text lines 310 and 320. For example, the first text line 310 may be associated with the first text line selection. For example, a text line selection may be exclusively associated with one text line among the plurality of text lines 310 and 320 while the other text line (or the other text lines) is not associated with the text line selection.

In some embodiments, the text line selection key (TL) 515 may be configured for a text line associated with the text line selection key (TL) 515 to be changed in a periodic manner based on a count of key inputs. For example, the text line selection key (TL) 515 may be configured to be associated with the first text line 310 if the count of key inputs on the text line selection key is odd, and the text line selection key (TL) 515 may be configured to be associated with the second text line 320 if the count of key inputs on the text line selection key is even.

For example, if a key input on the text line selection key (TL) 515 is firstly received, the text line selection key (TL) 515 may be associated with the first text line 310. For example, if a key input on the text line selection key (TL) 515 is received one more time after the text line selection key (TL) 515 is associated with the first text line 310, the text line selection key (TL) 515 may be associated with another text line (e.g., the second text line 320) rather than the first text line 310. For example, if a key input on the text line selection key (TL) 515 is received one more time after the text line selection key (TL) 515 is associated with the second text line 320, the text line selection key (TL) 515 may be associated with the first text line 310 again. However, a text line selection is not limited to a key input, and may include a gesture input, and so on.

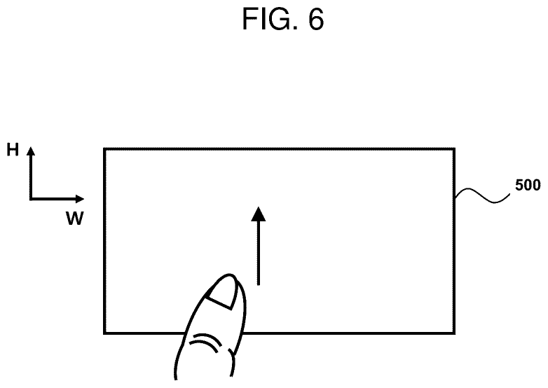

FIG. 6 is an exemplary drawing illustrating an input of a text line selection that may be performed in step S11 in a method of inputting characters according to an embodiment of the disclosure.

Referring to FIG. 6, a text line selection may include a gesture input on the device 100 from a user. For example, a gesture input from a user may include a gesture input on the keyboard area 500. A gesture input on the keyboard area 500 may include a gesture input in a transverse direction W of the keyboard area 500, a height direction H of the keyboard area 500, or any combination thereof. For example, a gesture input may include a gesture input in a diagonal direction between the transverse direction W and the height direction H.

For example, a gesture input may include a drag gesture input, a swipe gesture input, a tap gesture input, a pinch gesture input, and so on. For example, a gesture input may be a gesture input based on a single touch position, a gesture input based on multiple touch positions, a gesture input based on an eye line of a user, a gesture input based on a movement of a wrist, and so on.

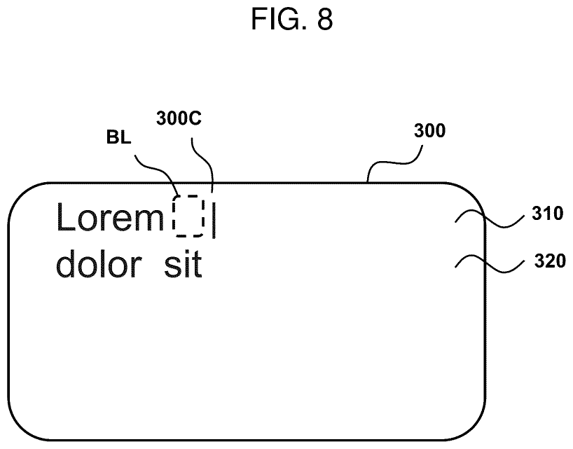

FIG. 7 and FIG. 8 are exemplary drawings respectively illustrating a text input area before step S11 in a method of inputting characters according to embodiments of the disclosure. Referring to FIG. 7 and FIG. 8, before step S11, it is assumed that at least one blank character BL is positioned after characters of “Lorem” in the first text line 310 in the text input area 300, but the assumption is just an example for convenience of description. That is, before step S11, there is no need to include a blank character at a last character position (or at a last substring position) before a new-line character in one text line in the text input area 300.

In some embodiments, before step S11, characters positioned in a plurality of text lines in the text input area 300 may end in a writing direction, in at least two text lines, at substantially the same or similar positions. In the disclosure, characters ending at substantially the same or similar positions in different text lines means that, for example, a transverse difference between end positions of last characters, in a writing direction in at least two text lines, among the characters positioned in the plurality of text lines in the text input area 300 may be equal to or less than a width of a character among the characters positioned in the plurality of text lines.

For example, referring to FIG. 7, a difference between an end position E1 of a last character (a blank character BL) in the first text line 310 and an end position E2 of a last character “t” in the second text line 320 may be ΔE in a transverse direction W. Here, ΔE is a transverse difference between an end position of the last character in the first text line 310 and an end position of the last character in the second text line 320. ΔE may be greater than zero (0) if the end position E1 of the last character in the first text line 310 is further to the left or further to the right than the end position E2 of the last character in the second text line 320, or ΔE may be zero (0) if the two end positions E1 and E2 are at substantially the same positions in a transverse direction W.

In some embodiments, ΔE may be equal to or less than a width of a certain character among the characters positioned in the first text line 310 and the second text line 320. For example, ΔE may be less than a width of lowercase m. For example, ΔE may be less than a width of lowercase i. For example, ΔE may be less than a width of uppercase L. For example, ΔE may have a substantially zero size in a transverse direction W.

In some embodiments, if ΔE is less than a predetermined width (e.g., a width of a character among plural characters positioned in a plurality of text lines), an alternate input of a character and/or a blank character across text lines may be clearly represented.

Referring to FIG. 7, in some embodiments, there may be substantially no change in the text input area 300 before and after step S11. For example, after step S11, plural characters in the text input area 300 may remain the same as before step S11. In this case, a text input position 300C may remain in the second text line 320 as before step S11. For example, a text input position 300C may remain after a last character in the second text line 320 not associated with the first text line selection.

Referring to FIG. 8, in some embodiments, after step S11, plural characters in the text input area 300 may remain the same as before step S11. However, unlike FIG. 7, a text input position 300C may be located in the first text line 310 rather than the second text line 320 in which the text input position 300C was located before step S11. For example, a text input position 300C may be located after a last character in the first text line 310 associated with the first text line selection.

Referring to FIG. 5 again, in step S12, the device 100 may be configured to receive an input of a first character key associated with a first character among a plurality of keys in the keyboard area. For example, referring to FIG. 1 and FIG. 2, the device 100 may be configured to receive an input of a first character key 511 associated with a first character among a plurality of keys 510 in the keyboard area 500. For example, the first character may be an uppercase “A”, and the first character key 511 may be a character key associated with the uppercase “A”. However, this is just an example, and the first character may be any character such as a Unicode character, an emoji character, and so on.

Referring to FIG. 5, in step S13, the device 100 may be configured to provide, in the text input area 300, the first character in the first text line associated with the first text line selection and a first blank character in each of the plurality of text lines, except the first text line, including the second text line. For example, if the plurality of text lines are two text lines, the device 100 may be configured to provide the first character in one text line associated with the first text line selection and a first blank character in the other text line not associated with the first text line selection.

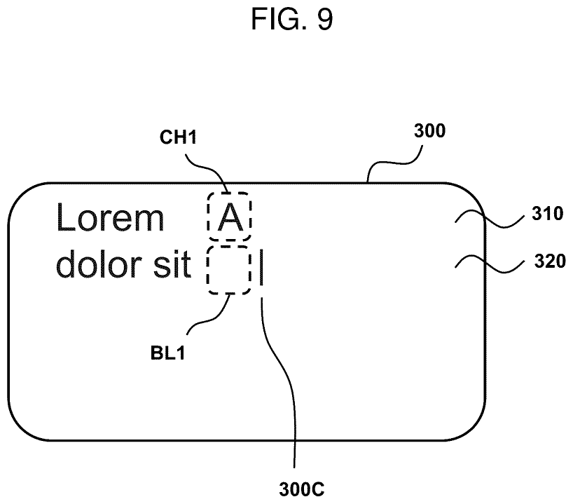

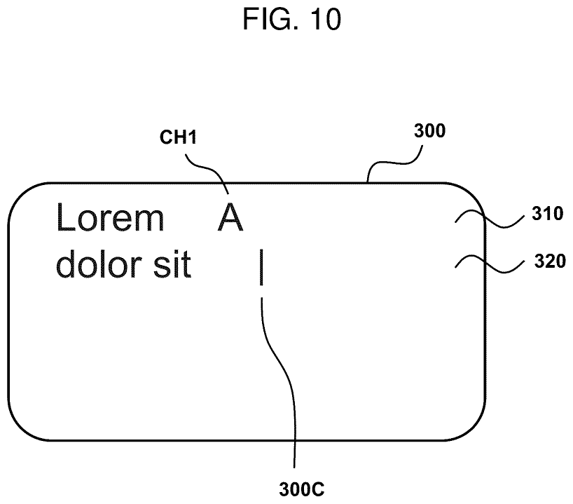

FIG. 9 and FIG. 10 are exemplary drawings respectively illustrating a text input area after step S13 in a method of inputting characters according to embodiments of the disclosure.

Referring to FIG. 9 and FIG. 10, in step S13, if the first text line 310 was associated with the first text line selection in step S11, an uppercase “A” CH1 which was associated with the first character key in step S12 may be provided in the first text line 310, and a first blank character BL1 may be provided in the second text line 320, which was not associated with the first text line selection. FIG. 10 is substantially the same as FIG. 9 except that the first blank character BL1 is not illustrated.

Referring to FIG. 7 and FIG. 10, the device 100 may be configured to provide characters in plural text lines based on a text line selection (and its associated text line) performed in step S11, and this is different from providing a (non-blank) character only at a text input position 300C in the text input area 300. In this case, the characters in plural text lines may include a non-blank character in a text line associated with the text line selection and a blank character in a text line not associated with the text line selection.

As mentioned above, by providing a non-blank character and a blank character in plural text lines based on a text line selection, characters may be easily provided in the text input area 300 to have a desired spatial arrangement from a combination of positions in a transverse direction W and a height direction H in the text input area 300.

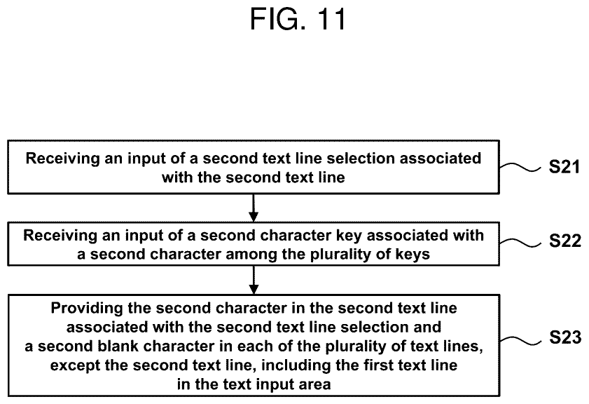

FIG. 11 is a flow chart illustrating a method of inputting characters according to an embodiment of the disclosure.

Referring to FIG. 5 and FIG. 11, a method of inputting characters according to an embodiment of the disclosure may further include, after step S13, a step S21 of receiving an input of a second text line selection associated with the second text line, a step S22 of receiving an input of a second character key associated with a second character among the plurality of keys, and a step S23 of providing the second character in the second text line associated with the second text line selection and a second blank character in each of the plurality of text lines, except the second text line, including the first text line in the text input area.

In step S21, the device 100 may be configured to receive an input of a second text line selection. The second text line selection may be associated with a second text line. For example, referring to FIG. 10, the second text line selection may be associated with the second text line 320.

In step S22, the device 100 may be configured to receive an input of a second character key associated with a second character among the plurality of keys. For example, referring to FIG. 1 and FIG. 2, the device 100 may be configured to receive an input of a second character key 511 associated with a second character among the plurality of keys 510. For example, the second character may be an uppercase “B”, and the second character key 511 may be a character key associated with the uppercase “B”. However, this is just an example, and the second character may be any character such as a Unicode character, an emoji character, and so on.

In step S23, the device 100 may be configured to provide, in the text input area, the second character in the second text line associated with the second text line selection and a second blank character in each of the plurality of text lines, except the second text line, including the first text line.

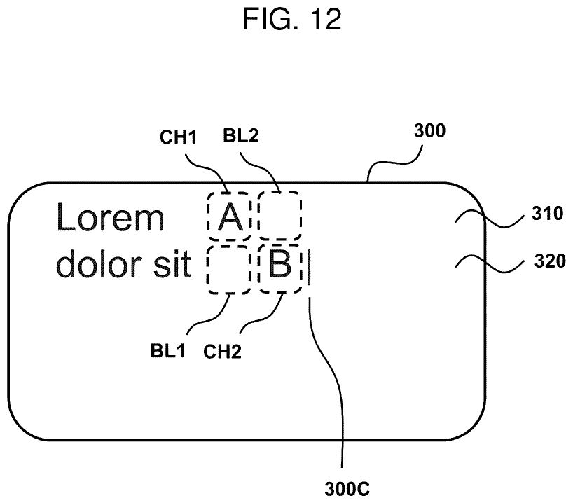

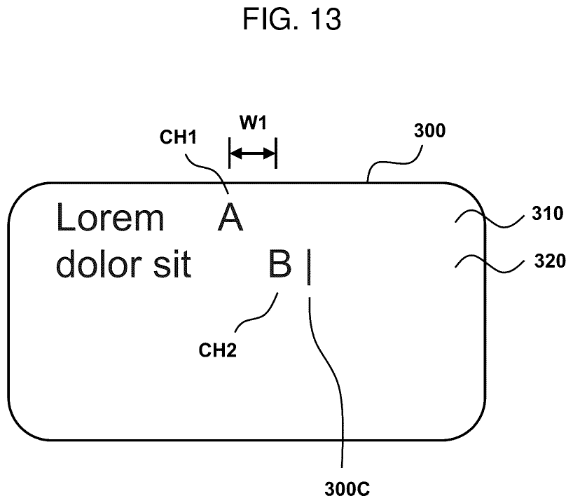

FIG. 12 and FIG. 13 are exemplary drawings respectively illustrating a text input area after step S23 in a method of inputting characters according to embodiments of the disclosure.

Referring to FIG. 12 and FIG. 13, in step S23, if the second text line 320 was associated with the second text line selection in step S21, an uppercase “B” CH2 which was associated with the second character key in step S22 may be provided in the second text line 320, and a second blank character BL2 may be provided in the first text line 310 not associated with the second text line selection. FIG. 13 is substantially the same as FIG. 12 except that blank characters BL1 and BL2 are not illustrated.

Referring to FIG. 13, the second character CH2 provided in the second text line 320 may be positioned in a diagonal direction with respect to the first character CH1 provided in the first text line 310. In this case, a center of the second character CH2 may be spaced apart from a center of the first character CH1 by a first distance W1 in a transverse direction. However, the distance that the first character CH1 and the second character CH2 may be positioned in a diagonal direction is not limited thereto. For example, in step S13, a plurality of blank characters may be provided in text lines not associated with the first text line selection when the first character CH1 is provided. Similarly, in step S23, a plurality of blank characters may be provided in text lines not associated with the second text lines selection when the second character CH2 is provided.

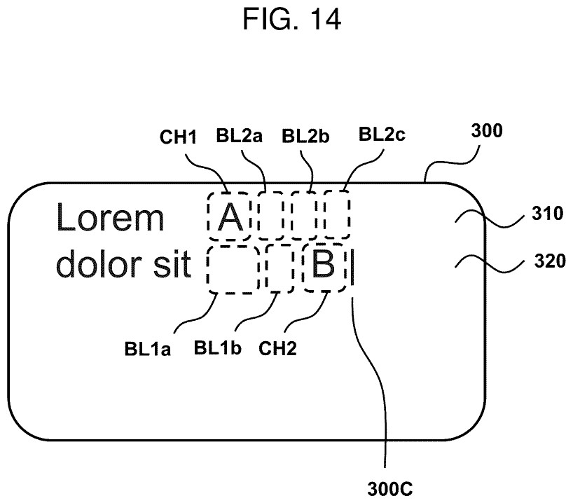

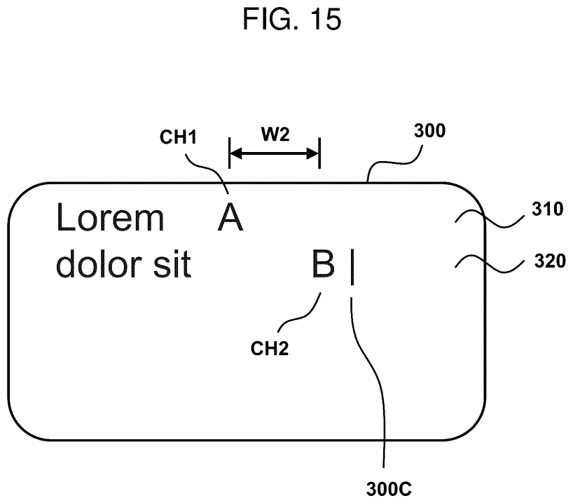

FIG. 14 and FIG. 15 are exemplary drawings respectively illustrating a text input area after step S23 in a method of inputting characters according to embodiments of the disclosure.

Referring to FIG. 14 and FIG. 15, when the first character CH1 is provided in the first text line 310, a first plurality of blank characters BL1a and BL1b may be provided in other text line 320 rather than the first text line 310. The first plurality of blank characters BL1a and BL1b may have different widths from each other. For example, a width of one blank character BL1a of the first plurality of blank characters BL1a and BL1b may be greater than a width of another blank character BL1b of the first plurality of blank characters BL1a and BL1b. For example, the blank characters having different widths may include Unicode characters (e.g., U+2000, U+2001, etc.).

Similarly, when the second character CH2 is provided in the second text line 320, a second plurality of blank characters BL2a, BL2b, and BL2c may be provided in other text line 310 rather than the second text line 320. The second plurality of blank characters BL2a, BL2b, and BL2c may have different widths from each other or the same width as each other. Furthermore, a width of one of the second plurality of blank characters BL2a, BL2b, and BL2c may be the same as or different from a width of one of the first plurality of blank characters BL1a and BL1b. In some embodiments, in a writing direction, a last character BL2c of the second plurality of blank characters in the first text line 310 may end at substantially the same or similar position as a last character CH2 in the second text line 320.

FIG. 15 is substantially the same as FIG. 14 except that blank characters BL1a, BL1b, BL2a, BL2b, and BL2c are not illustrated. Referring to FIG. 15, the second character CH2 provided in the second text line 320 may be positioned in a diagonal direction with respect to the first character CH1 provided in the first text line 310. In this case, a center of the second character CH2 may be spaced apart from a center of the first character CH1 by a second distance W2 in a transverse direction. Referring to FIG. 13 and FIG. 15, the second distance W2 between the center of the first character CH1 and the center of the second character CH2 in a transverse direction in the text input area 300 may be greater than the first distance W1.

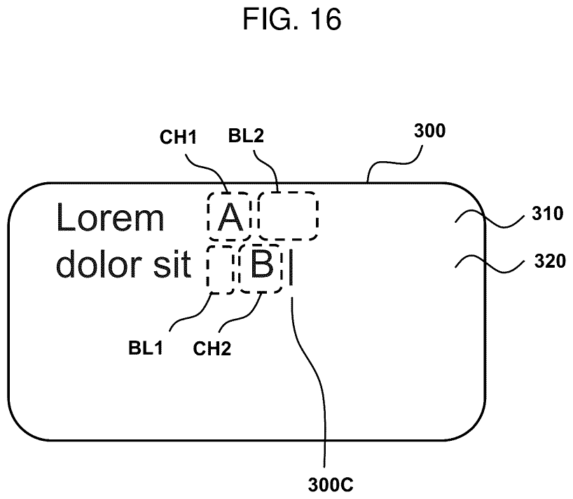

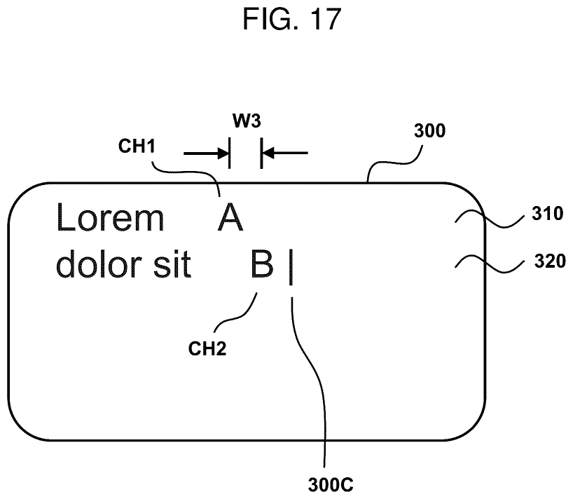

FIG. 16 and FIG. 17 are exemplary drawings respectively illustrating a text input area after step S23 in a method of inputting characters according to embodiments of the disclosure.

Referring to FIG. 16 and FIG. 17, when the first character CH1 is provided in the first text line 310 in step S13, a first blank character BL1 may be provided in other text line 320 rather than the first text line 310. After that, when the second character CH2 is provided in the second text line 320 in step S23, a second blank character BL2 may be provided in the first text line 310 rather than the second text line 320. In this case, a width of the first blank character BL1 may be the same as or different from a width of the second blank character BL2. For example, a width of the first blank character BL1 may be less than a width of the second blank character BL2.

FIG. 17 is substantially the same as FIG. 16 except that blank characters BL1 and BL2 are not illustrated. Referring to FIG. 13 and FIG. 17, a third distance W3 between the center of the first character CH1 and the center of the second character CH2 in a transverse direction in the text input area 300 may be less than the first distance W1.

As mentioned above, a number, a width, or a combination thereof of blank characters provided in text lines not associated with text line selection may be changed, thereby altering a transverse distance W1, W2, and W3 between the first character CH1 and the second character CH2.

In some embodiments, the method of inputting characters may further include receiving an input of blank width adjustment in the keyboard area. For example, the input of blank width adjustment may include a gesture input, a key input, etc. on the keyboard area 500. For example, referring to FIG. 1 and FIG. 2, if the plurality of keys 510 includes a blank width adjustment key WT 517 in the keyboard area 500, the input of blank width adjustment may include a key input on the blank width adjustment key WT 517.

When receiving the input of blank width adjustment, the device 100 may be configured to change a transverse distance between the first character CH1 in the first text line 310 and the second character CH2 in the second text line 320 in the text input area 300 in response to the input of blank width adjustment. For example, if an input on the blank width adjustment key WT 517 includes a swipe input, the device 100 may be configured to increase a transverse distance between the first character CH1 and the second character CH2 when the swipe input is provided in a writing direction. For example, referring to FIG. 12 and FIG. 14, the device 100 may be configured to change the first blank character BL1 illustrated in FIG. 12 into the first plurality of blank characters BL1a and BL1b illustrated in FIG. 14. This change of blank characters may be performed by, e.g., deleting the first blank character BL1 before the second character CH2 in the second text line 320 and inserting the first plurality of blank characters BL1a and BL1b before the second character CH2 in the second text line 320.

Similarly, for example, if an input on the blank width adjustment key WT 517 includes a swipe input, the device 100 may be configured to decrease a transverse distance between the first character CH1 and the second character CH2 when the swipe input is provided against a writing direction.

For example, referring to FIG. 12 and FIG. 16, the device 100 may be configured to change the first blank character BL1 illustrated in FIG. 12 into the first blank character BL1 illustrated in FIG. 16. This change of blank characters may be performed by, e.g., deleting the first blank character BL1 in FIG. 12 before the second character CH2 in the second text line 320 and inserting the first blank character BL1 in FIG. 16 before the second character CH2 in the second text line 320.

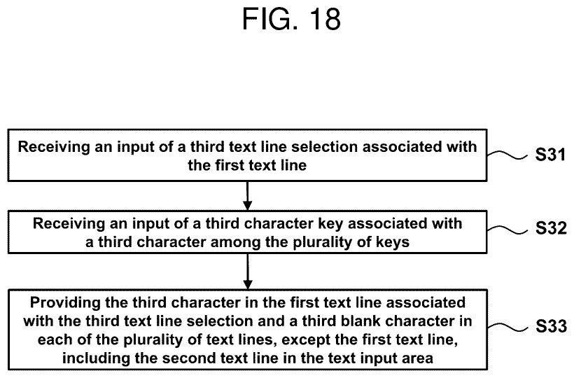

FIG. 18 is a flow chart illustrating a method of inputting characters according to an embodiment of the disclosure.

Referring to FIG. 18, the method of inputting characters according to an embodiment of the disclosure may further include, after step S23, a step S31 of receiving an input of a third text line selection associated with the first text line, a step S32 of receiving an input of a third character key associated with a third character among the plurality of keys, and a step S33 of providing the third character in the first text line associated with the third text line selection and a third blank character in each of the plurality of text lines, except the first text line, including the second text line in the text input area.

In step S31, the device 100 may be configured to receive an input of a third text line selection. The third text line selection may be associated with the first text line. For example, referring to FIG. 17, the third text line selection may be associated with the first text line 310.

In step S32, the device 100 may be configured to receive a third character key associated with a third character among the plurality of keys. For example, referring to FIG. 1 and FIG. 2, the device 100 may be configured to receive an input of a third character key 511 associated with a third character among the plurality of keys 510. For example, the third character may be an uppercase “C”, and the third character key 511 may be a character key associated with the uppercase “C”. However, this is just an example, and the third character may be any character such as a Unicode character, an emoji character, and so on.

In step S33, in response to the input of third character key, the device 100 may be configured to provide the third character in the first text line associated with the third text line selection and a third blank character in each of the plurality of text lines, except the first text line, including the second text line in the text input area.

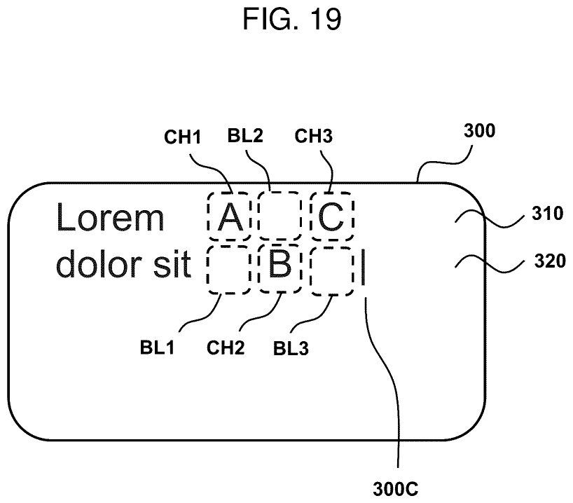

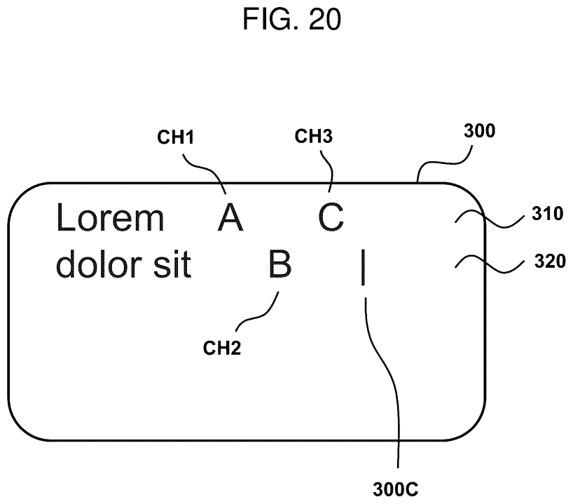

FIG. 19 and FIG. 20 are exemplary drawings respectively illustrating a text input area after step S33 in a method of inputting characters according to embodiments of the disclosure.

Referring to FIG. 19 and FIG. 20, when the first character CH1 is provided in the first text line 310 in step S13, a first blank character BL1 may be provided in other text line 320 rather than the first text line 310. After that, when the second character CH2 is provided in the second text line 320 in step S23, a second blank character BL2 may be provided in the first text line 310 rather than the second text line 320. After that, when the third character CH3 is provided in the first text line 310 in step S33, a third blank character BL3 may be provided in the second text line 320 rather than the first text line 310. FIG. 20 is substantially the same as FIG. 19 except that blank characters BL1, BL2, and BL3 are not illustrated. As mentioned above, by alternating associated text lines based on text line selections, the first character CH1, the second character CH2, and the third character CH3 may be positioned in a zigzag manner in a height direction in the text input area 300.

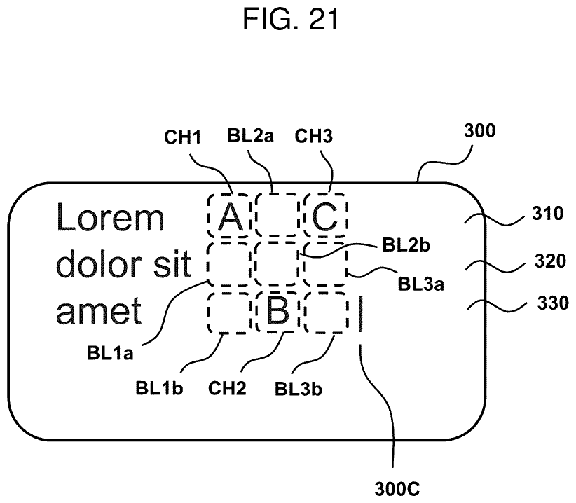

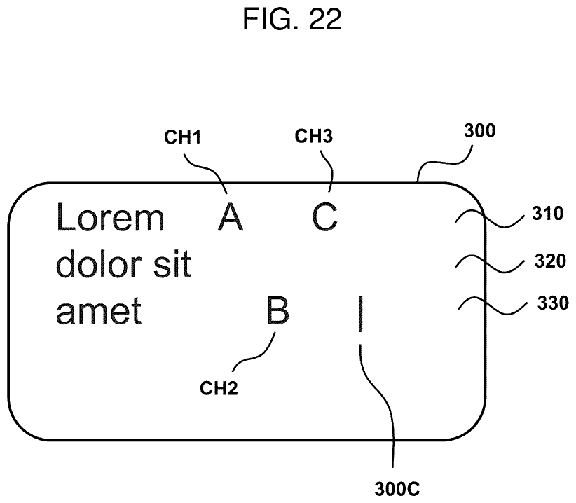

FIG. 21 and FIG. 22 are exemplary drawings respectively illustrating a text input area after step S33 in a method of inputting characters according to embodiments of the disclosure.

Referring to FIG. 21 and FIG. 22, when the first character CH1 is provided in the first text line 310 in step S13, first blank characters BL1a and BL1b may be provided in other text lines 320 and 330 rather than the first text line 310. After that, when the second character CH2 is provided in the second text line 330 in step S23, second blank characters BL2a and BL2b may be provided in other text lines 310 and 320 rather than the second text line 330. After that, when the third character CH3 is provided in the first text line 310 in step S33, third blank characters BL3a and BL3b may be provided in other text lines 320 and 330 rather than the first text line 310. FIG. 22 is substantially the same as FIG. 21 except that blank characters BL1a, BL1b, BL2a, BL2b, BL3a, and BL3b are not illustrated. As mentioned above, by alternating associated text lines based on text line selections when plural characters are positioned in three text lines, the first character CH1, the second character CH2, and the third character CH3 may be positioned in a zigzag manner in a height direction in the text input area 300.

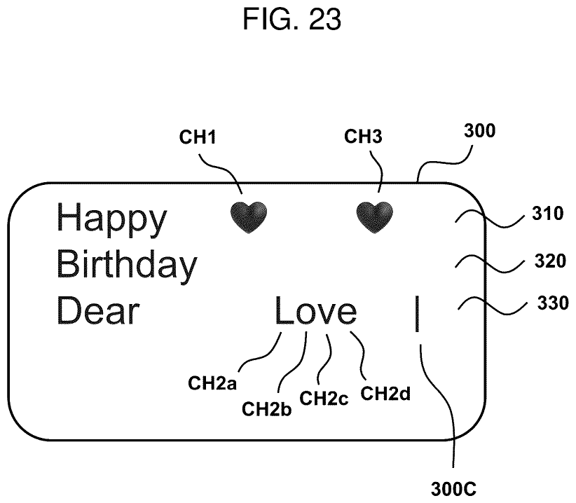

FIG. 23 is an exemplary drawing illustrating a text input area after step S33 in a method of inputting characters according to an embodiment of the disclosure.

Referring to FIG. 23, when the first character CH1 is provided in the first text line 310 in step S13, first blank characters may be provided in other text lines 320 and 330 rather than the first text line 310. After that, when second characters CH2a, CH2b, CH2c, and CH2d are provided in the second text line 330 in step S23, second blank characters may be provided in other text lines 310 and 320 rather than the second text line 330 unless additional text line selection is input. After that, when the third character CH3 is provided in the first text line 310 in step S33, third blank characters may be provided in other text lines 320 and 330 rather than the first text line 310. As mentioned above, if additional text line selection is not input when a Unicode character, an emoji character etc. are provided in a text line associated with a last text line selection, blank characters may be provided in text lines not associated with the last text line selection. After that, if another text line selection is input, then a position of a Unicode character, an emoji character, etc. may be changed in a height direction, thereby arranging the first character CH1, the second character string CH2a, CH2b, CH2c, and CH2d, and the third character CH3 in a zigzag manner in a height direction in the text input area 300.

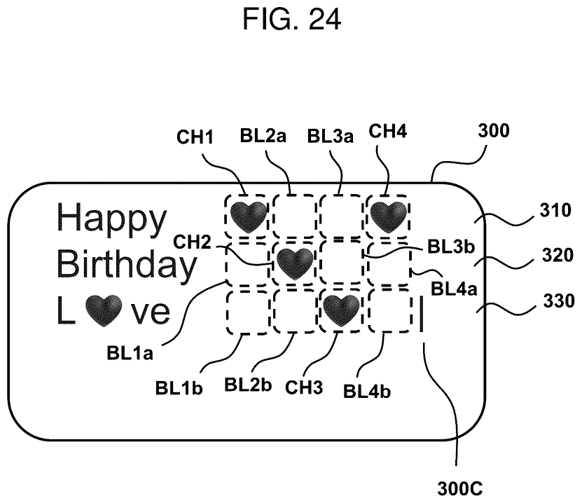

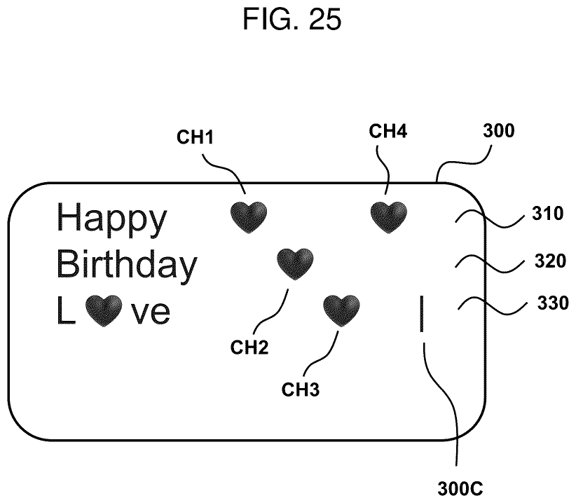

FIG. 24 and FIG. 25 are exemplary drawings respectively illustrating a text input area after step S33 in a method of inputting characters according to embodiments of the disclosure.

Referring to FIG. 24 and FIG. 25, when the first character CH1 is provided in the first text line 310 in step S13, first blank characters BL1a and BL1b may be provided in other text lines 320 and 330 rather than the first text line 310. After that, when the second character CH2 is provided in the second text line 320 in step S23, second blank characters BL2a and BL2b may be provided in other text lines 310 and 330 rather than the second text line 320. After that, if the third text line selection is associated with a third text line 330 in step S31, the third character CH3 may be provided in the third text line 330 and third blank characters BL3a and BL3b may be provided in other text lines 310 and 320 rather than the third text line 330 in step S33. After that, if a fourth text line selection (associated with the first text line 310) is input again and a fourth character key associated with a fourth character is input, then the fourth character CH4 may be provided in the first text line 310 associated with the fourth text line selection and fourth blank characters BL4a and BL4b may be provided in other text lines 320 and 330 rather than the first text line 310. FIG. 25 is substantially the same as FIG. 24 except that blank characters BL1a, BL1b, BL2a, BL2b, BL3a, BL3b, BL4a, and BL4b are not illustrated. As mentioned above, by alternating associated text lines in a periodic manner based on inputs of text line selection, a Unicode character, an emoji character, etc. may be positioned in a desired spatial arrangement in alternating text lines in the text input area 300.

As discussed above, it should be understood that certain steps in a method of inputting characters according to embodiments of the disclosure may be performed in a different order or substantially the same order as each other without departing from the scope of the disclosure.

One skilled in the art should understand that a character discussed in embodiments of the disclosure may be implemented as a character type, and so on. Furthermore, one skilled in the art should understand that plural characters discussed in embodiments of the disclosure may be implemented as an array of characters, a character string, a substring, and so on. However, an implementation of plural characters is not limited to an array, a string, or a substring, and one skilled in the art should understand that plural characters may be implemented, e.g., as a data type that may be stored and/or referenced including a plurality of character types, and so on.

Furthermore, one skilled in the art should understand that inputs of characters in plural text lines as mentioned above in embodiments of the disclosure may be implemented in a various ways, e.g., by respectively inputting a character(s) at a desired position in the text input area, or by deleting the entire characters in the text input area and then inputting characters again including a character(s) to be added or inserted in the text input area.

According to embodiments, in order to provide various spatial arrangement of characters, a method of inputting characters may be configured to be applied only in a single application, or in any number of applications that the characters may be provided.

For example, if the device 100 is a smartphone or tablet computer that includes a touchscreen, the method of inputting characters according to an embodiment may be implemented in a form of a keyboard application extension program, which may be applied to an independent application executable on an operating system of the smartphone or tablet computer. In this case, a method of inputting characters may be implemented e.g., as follows: if a desired request (e.g., a key input, etc.) is transferred to the keyboard application extension program from a host application executable on the device 100 by a system control program such as, e.g., the operating system or kernel of the device 100, then the keyboard application extension program may perform a process for the request and may transfer a result back to the host application. Thus, a method of inputting characters according to embodiments of the disclosure may be implemented for any host application that the keyboard application extension program may be applied.

For example, if the device 100 is a smartphone or tablet computer that includes a touchscreen, the method of inputting characters according to an embodiment may be implemented in a form of a system input interface module executable on an operating system of the smartphone or tablet computer. In this case, the method of inputting characters according to an embodiment of the disclosure may be implemented as an example of an optional keyboard interface module, which is added to a conventional keyboard interface module executable on the operating system.

The above-mentioned implementations are exemplary only, and they are not intended to limit implementations of a method of inputting characters according to embodiments. For example, devices and methods of inputting characters according to embodiments may be implemented in a form of computing devices described above, as well as in a form of computer-executable (and/or computer-readable) instructions that may be stored in a tangible, non-transient computer-readable storage medium and performed on various computer systems. In addition, a computer program according to embodiments of the disclosure may be implemented in a form of an application for personal computers or mobile devices, or in a form of an application extension program. An application may be installed on the device via one or more files provided by a file distribution system. In this case, the file distribution system may send a file including the program to the device based on a request from the device.

While various exemplary embodiments of devices and methods have been described above, they have been presented for purposes of example only, not limitations. It is not exhaustive and does not limit the disclosure to the precise form disclosed. Modifications and variations are possible considering the above teachings or may be acquired from practicing of the disclosure, without departing from the scope of the disclosure.

1. A method of inputting characters capable of being performed on a device,
wherein the device includes a text input area and a keyboard area,
wherein the keyboard area includes a plurality of keys, and the method comprising:
receiving, in the keyboard area, an input of a first text line selection associated with a first text line if characters are positioned in a plurality of text lines including the first text line and a second text line in the text input area;
receiving an input of a first character key associated with a first character among the plurality of keys after the receiving the input of the first text line selection; and
providing, in response to the input of the first character key, the first character in the first text line associated with the first text line selection and a first blank character in each of the plurality of text lines, except the first text line, including the second text line in the text input area.

2. The method of claim 1,
wherein the plurality of keys further includes a text line selection key, and
wherein the input of the first text line selection includes a key input on the text line selection key.

3. The method of claim 2,
wherein the text line selection key is configured for a text line associated with the text line selection key to be changed periodically among the plurality of text lines based on a count of key inputs on the text line selection key.

4. The method of claim 3,
wherein the text line selection key is configured to be associated with the first text line if the count of key inputs on the text line selection key is odd, and the text line selection key is configured to be associated with the second text line if the count of key inputs on the text line selection key is even.

5. The method of claim 1,
wherein the input of the first text line selection includes a gesture input on the keyboard area.

6. The method of claim 5,
wherein the gesture input includes at least one of a drag gesture, a swipe gesture, a tap gesture, and a pinch gesture.

7. The method of claim 1,
wherein the first character is a Unicode character or an emoji character.

8. The method of claim 7,
wherein the emoji character is configured to have an animation effect.

9. The method of claim 1,
wherein the first text line is above the second text line in the text input area.

10. The method of claim 1,
wherein a transverse difference between end positions of last characters, in a writing direction in each text line, among the characters positioned in the plurality of text lines including the first text line and the second text line is equal to or less than a width of a character among the characters positioned in the plurality of text lines.

11. The method of claim 1,
wherein the providing the first character in the first text line and the first blank character in each of the plurality of text lines except the first text line includes:
providing the first character in the first text line and a plurality of blank characters in each of the plurality of text lines except the first text line.

12. The method of claim 11,
wherein widths of the plurality of blank characters are different from each other in the text input area.

13. The method of claim 1,
wherein after the providing the first character in the first text line and the first blank character in each of the plurality of text lines except the first text line, the method further comprising:
receiving, in the keyboard area, an input of a second text line selection associated with the second text line;
receiving an input of a second character key associated with a second character among the plurality of keys after the receiving the input of the second text line selection; and
providing, in response to the input of the second character key, the second character in the second text line associated with the second text line selection and a second blank character in each of the plurality of text lines, except the second text line, including the first text line in the text input area.

14. The method of claim 13,
wherein the second character is provided in a diagonal direction with respect to the first character in the text input area.

15. The method of claim 13,
wherein at least one of the first character and the second character is a Unicode character.

16. The method of claim 13,
wherein a width of the first blank character is different from a width of the second blank character in the text input area.

17. The method of claim 13,
wherein after the providing the second character in the second text line and the second blank character in each of the plurality of text lines except the second text line, the method further comprising:
receiving an input of blank width adjustment in the keyboard area, and
wherein a transverse distance between the first character in the first text line and the second character in the second text line is configured to be changed in the text input area in response to the input of blank width adjustment.

18. The method of claim 17,
wherein the input of blank width adjustment includes at least one of a gesture input on the keyboard area and a key input on a key among the plurality of keys.

19. The method of claim 13,
wherein after the providing the second character in the second text line and the second blank character in each of the plurality of text lines except the second text line, the method further comprising:
receiving, in the keyboard area, an input of a third text line selection associated with the first text line;
receiving an input of a third character key associated with a third character among the plurality of keys after the receiving the input of the third text line selection; and
providing, in response to the input of the third character key, the third character in the first text line associated with the third text line selection and a third blank character in each of the plurality of text lines, except the first text line, including the second text line in the text input area.

20. The method of claim 19,
wherein the first character, the second character and the third character are arranged in a zigzag manner in a height direction in the text input area.
